(19) United States
(12) Patent Application Publication
(10) Pub. No.: US 2007/0050239 A1
(43) Pub. Date: Mar. 1, 2007

(54) Method for managing organizational capabilities

(76) Inventor: Duane C. Caneva, Gaithersburg, MD (US)

Correspondence Address: NAVAL MEDICAL RESEARCH CENTER;ATTN: (CODE 00L), 503 ROBERT GRANT AVENUE, SILVER SPRING, MD, 20910-7500, US

(21) Appl. No.: 11/508,575

(22) Filed: Aug. 23, 2006

Related U.S. Application Data
(60) Provisional application No. 60/712,610, filed on Aug. 24, 2005.

(51) Int. Cl. G06F 11/34

(52) U.S. Cl. 705/11

(57) ABSTRACT

The invention pertains to a method of analyzing an organization's personnel and material resource data in order to provide organizational managers decision options in order maximize an organization's ability to perform its designated mission. The method is also contemplated to be able to be incorporated into a computer language such that decision options can be provided to managers in a real-time basis. Analysis of an organization is reduced to the organization's readiness and preparedness to perform designated tasks based on standardized capabilities. The analysis is capable of providing advice through all hierarchical levels within an organization. The analysis is also capable of determining changes to the readiness and preparedness components in order to improve the metrics.

### CROSS-REFERENCE TO RELATED APPLICATIONS

This application claims priority to provisional application No. 60/712,610 filed Aug. 24, 2005. The application 60/712,610 is hereby incorporated by reference.

### BACKGROUND OF THE INVENTION

1. Field of the Invention

The current invention relates to a method of evaluating the readiness profile of an organization including medical facilities. The method is particularly suited for managing the response capabilities of a medical facility. The method is a management tool that determines “readiness factors” and “preparedness factors” used that, through a series, provides an evaluation of an organization's ability to perform required capabilities and ultimately provides advisory information to managers, at multiple management tiers, on what corrective action would be most effective at maximizing the organizations readiness and preparedness.

2. Description of the Related Art

Since the events of 11 Sep. 2001, the importance of readiness and preparedness has received new focus, especially in medical treatment facilities. The National Response Plan (NRP) outlines further in detail the U.S. national strategy and identifies the supporting agencies and what entities are supported. Promulgation of a National Incident Management System (NIMS) with its focus on integration has given impetus to development of a systematic approach for a national response strategy.

Identifying the complexities of the coordination, integration, and interoperability requirements and capturing them in models to which information management methods can be applied and to which useful information is obtained, becomes a challenge. While readiness and preparedness are important, operational risk management and responsiveness are also critical elements of a successful strategy. Developing a capable response to given mission or task requirements from the available capability resources requires clear identification of those assets are and what the risk is in using the given resources across a “capabilities gap” to meet operational requirements, requiring development of a methodology for performing operational risk management.

Process methods for the optimization of business processes have been disclosed. For example, the patent to M. Ernst (U.S. Pat. No. 5,890,133 issued Mar. 30, 1999) teaches a process for the optimization of a business process by identifying events of carrying out a business process and then making modifications based on result data that meet predetermined criteria. Additionally, processes or methods addressing risk management of business resources have been disclosed. For example Mittal and Goel (Patent Application No. US 2005/0144062, filed Jun. 30, 2005) teaches a method for the generation of business continuity readiness indicators, in which a computerized system is used to notify designated employees a deadline for submitting status of business continuity responsibility. Additionally, resource and asset management methods and processes have been disclosed. For example, Chao et al (Patent Application No. US 2006/0020529, filed Jan. 26, 2006) and Levenson, et al (Patent Application No. US 2006/00220528 filed Jan. 26, 2006) teach methods for the visible management of transported assets. However, a comprehensive management process that evaluates and organization's readiness and preparedness to perform its designed missions or tasks, through standardized requirements are needed. This need is particularly acute in organizations that perform complex sets of tasks such as medical facilities.

### SUMMARY OF INVENTION

The current invention relates to a method for evaluating, monitoring and advising managers regarding the capabilities of an organization. The invention is broadly applicable to medical facilities as well as private companies and governmental agencies and entities. The invention, however, is particularly suited for managing organizations that have a response capability such as a medical facility. The method provides advice based on monitoring and evaluation of the organization in terms of measures of readiness, preparedness, personnel and management accountability and responsiveness. It is contemplated that the method will be incorporated into a computer program and that results from the method will be generated by computer.

The inventive method uses a “systems of systems” architectural model for task organization of capabilities-based resources within an organization for near real-time management decision-making capability. The method evaluates an organization's resources to give managers, at multiple levels of an organizations management hierarchy, a rapid assessment of organization shortfalls and task or mission capability. The method ultimately provides the results to managers by evaluating the organization in terms of readiness, preparedness, personnel and management accountability, and responsiveness assessed against centrally managed program standards, as defined by specific objectives and their attributes. The method applies defined capability requirements against a set of predetermined program standards providing a near real-time assessment of an organization's ability to carry out its required mission.

The inventive method allows for the evaluation of the organizations resources on a risk-based analysis, which encompasses the impact of issues related to selection of resources to be developed and ability of an organization to prepare for mission or task requirements adequately in a fiscally constrained environment. The inventive method also provides managers with an assessment of capability resource deployability and the impact on the donor organization of deploying resources enabling managers to allocate or deploy precious organizational resources or capabilities quickly and efficiently.

The inventive method allows for root cause analysis of data obtained from operation inputs such as after action reports, lessons learned, issues identified or direct input from subject matter experts, in order to identify causes of system failure. The method provides advice on how adjustment to the organization can be made based on assigned weighting factors representing the probability for the item to contribute towards a mission failure. Mapped to specific items within the system, adjustments of assigned weighting factors can be made, through either classical statistical modeling, hierarchical Bayesian Analysis, chaos theory fractal phasing or other models. This allows the model to use an evidence-based approach to adjust the program standards to drive the readiness factor towards a more meaningful measure of readiness.

### BRIEF DESCRIPTION OF DRAWINGS

FIG. 1. Illustration of relationship between standards and capabilities.

FIG. 2. Illustration of relationship between capabilities to capability groups (sets).

FIG. 3. Illustration of the “System of Systems” architecture and relationship between hazards (i.e., missions or tasks), required capabilities, objectives and attributes.

FIG. 4. Flow diagram of use of method by managers.

FIG. 5. Illustration of a methodology using the invention as part of a continuous improvement cycle.

FIG. 6. Illustration of how rank-ordering the program standards (i.e., Objectives) provides a framework for measuring “readiness” for a given required capability, providing a “readiness factor” (RF), and how the RF achieves a Benchmark Threshold for dashboard viewing.

FIG. 7. Illustration that the preparedness factor (PF) can be defined as the sum of capability readiness for a given capability set.

### DESCRIPTION OF THE PREFERRED EMBODIMENTS

The current invention is a capabilities-based method for real-time monitoring of capabilities of organizations such as private companies, governmental agencies and entities. The inventive method is particularly well suited for managing the response capabilities of medical facilities. The method enables analysis of facilities in terms of readiness, preparedness, personnel and management accountability and responsiveness against centrally managed program standards. Therefore, the method produces a number of analytical products. Most importantly, use of the method produces an evaluation of an organization's ability to conduct its mission and an assessment of issues that require management attention.

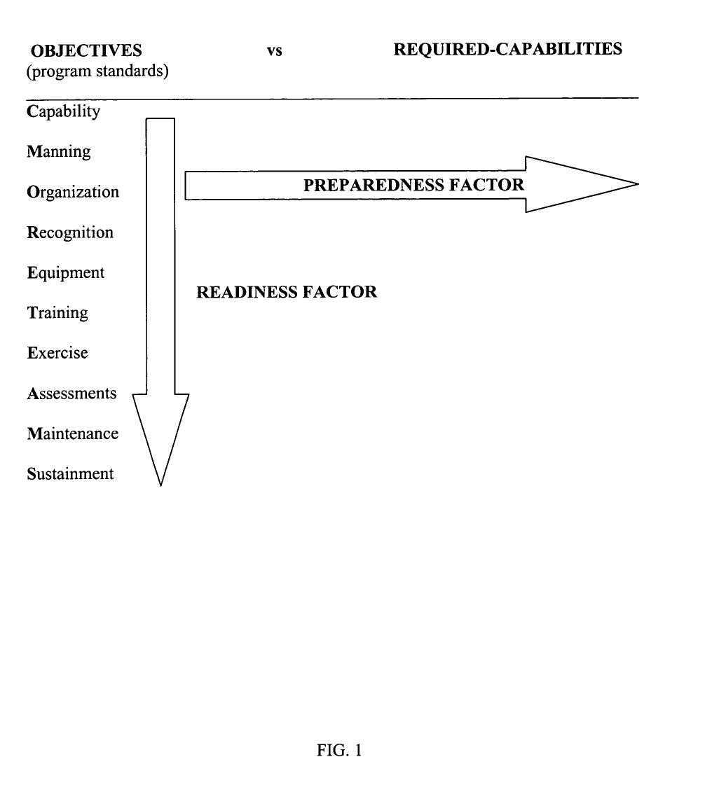

Referring to FIG. 1, the method applies specified and defined required capabilities that have been assigned a weighting factor based on the required-capabilities contribution toward organizational mission completion (or mission failure), against Objectives, encompassing program standards, providing a measure of readiness for a given required capability. Although other Objectives can be determined, depending on the organization, as an illustration, FIG. 1 shows the Objectives encompassed in the acronym “C MORE TEAMS” representing the following: Capability, Manning, Organization, Recognition (integration and interoperability), Equipment, Training, Exercise, Assessments, Maintenance, and Sustainment. Each of the objectives is further broken down into component attributes representing the point of irreducibility complexity of the given subsystem and one-to-one data entry. Required-capabilities are defined to represent the combination of defined standards to adequately equip, train and organize personnel and assets to integrate to perform their planned function. Incorporated in this method, “resources” represent the actual, physical personnel and assets.

The degree at which required-capability standards are met represents the level of “readiness”, defined by the “readiness factor”, of a specific capability. Using a system of systems model architecture, for a specific organizational program, required-capabilities are designated into groups or sets defining their level of criticality including “Baseline”, “Core”, “Contingency” and “Reactionary.” The capability groups or sets are defined as:
a. “Baseline” capabilities, defined as those performed on a daily basis. These are governed by standards such as credentialing, privileging, licensing, certifications, etc. Baseline may include, for example, mass casualty response capabilities that are based on every day skills, and do not require specialized training and equipment.
b. “Core” capabilities, are those that must meet the program standards for readiness. This capability set is inspected, used for planning and plans development, mutual aid agreements or memoranda of agreement, and are monitored in the warning and reporting algorithm. As an example, the Core capabilities for an “all hazards” Emergency Management Program may include required-capabilities needed for responding to chemical, biological and radiological and nuclear, high-yield explosives (CBRNE) incidents.
c. “Contingent” capabilities are those that are defined as part of core capability sets at other organizations but are not resourced within the organization of interest's program because of perceived lower risk, threat, or vulnerability to that organization. Examples include requirements for hurricane or tsunami preparations for organizations in non-coastal areas. These also include baseline require-capabilities that can be task organized for various missions or tasks not part of the core capability requirements. Standards are pre-defined and may be used for planning purposes, gaming or training exercises but do not necessarily require strict management and monitoring via the program standards. Use of these would be situational, such as for humanitarian response. For example, baseline capabilities would be organized after an incident to meet requirements calling for specific medical capabilities such as surgical specialties, nursing, public health specialists, etc. where standards are based on their credentialed privileges. While these would not require monitoring through the inventive method standards pre-incident, the method would provide visibility for planning and accountability during response. Additionally, the inventive method promotes more thorough planning through consideration of ancillary requirements captured in attributes that help to drive more comprehensive “required-capability” development(e.g. deploying technicians as part of a team, developing equipment lists for “go bags”, etc.).
d. “Reactionary” capabilities are those built “on-the-fly” from baseline and core capabilities for responding to unusual, unimagined response requirements, where, standards development might come from either local and/or central management. The inventive method promotes development and adherence to a common operating picture in allowing better visibility within the hierarchy what actual resource capabilities are, what support requirements might be, and what risk assessments have been made. During such crisis action planning, such operational risk management provides opportunity to justify exceptions that are made in developing the capability is promulgated in a risk assessment with better visibility across the hierarchy.

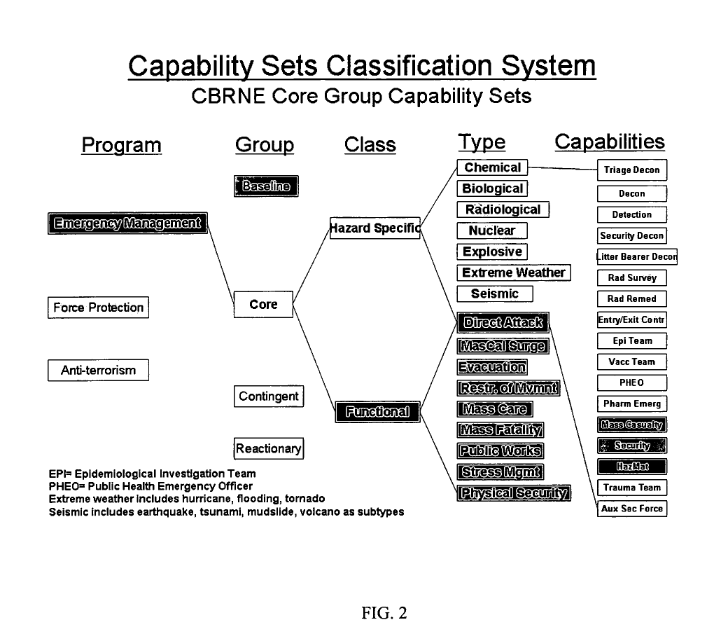

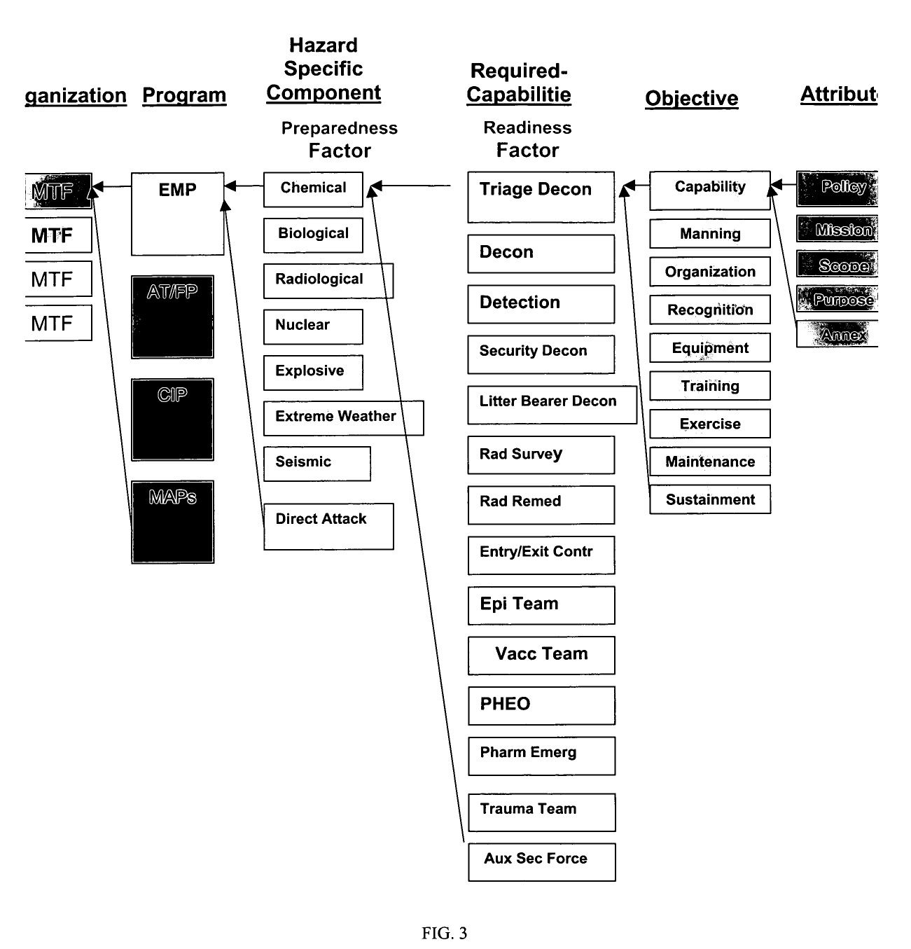

In a preferred embodiment, the groups are further divided into hazard specific and functional classes, which are further designated into specific types of required-capabilities in order to designate which capabilities are maintained, sustained and subject to inspection. FIG. 2 illustrates the relationships of the required-capabilities to required-capability groups, types and classes of required-capabilities. As an illustration of how required-capabilities are further defined by Objectives and Attributes, the reader is referred to FIG. 3.

Again referring to FIG. 1, capabilities, in compliance with program standards, are defined as in a mission capable, “ready” status. The set of capabilities that are “ready” for a specific mission or task, such as response to a specific hazard type, serve as a measure of “preparedness”. Another metric evaluated by the method is “responsiveness,” which measures the time from notification to being ready to execute a given mission or task. The method also evaluates metrics important to facilities that operate beyond a geographic base, such as military or other globally oriented health provider. In these cases, the metric, “deployability,” measures geospatial factors to include “prepare-to-deploy” time; time, ease, and ability to acquire adequate transportation; embarkation time; transport time; and debarkation time. “Operational risk management” principles guide the use of capabilities to meet given requirements, based on readiness, preparedness, responsiveness, and deployability. These measures can also provide significant insight into logistical support, time-phased force deployment data (TPFDD) requirements, for military or similarly deployed facilities, and cost of response, as well as overall program management, and development of the common operational picture.

Applied to hazard and threat assessments, readiness and preparedness factors can provide information on vulnerability and be used to manage risk, giving insight into local required-capability effectiveness. Risk, readiness, and responsiveness provide a measure of capability resource utility, allowing optimization of required-capability definitions and intelligent management of required-capabilities. Through an iterative process, the determination of required-capabilities can be vetted against local, regional, and national threat and hazard vulnerability assessments, adjusting the program's required-capabilities as needed in order to minimize risk, prepare for hazards identified, or decrease requirements when required-capabilities are no longer deemed to be needed. Therefore, for example, the method can be utilized by local, regional or national government planners in assessing their medical infrastructural capabilities.

An important inventive aspect of the current invention is that the method identifies critical program standards and indexes them against a range of required-capabilities organized in a matrix format. The technique is broadly applicable to any capabilities-based planning system, capturing critical elements through algorithms based on the standards and capabilities. As previously described above and as illustrated in FIG. 3, a “program objective” is a defined objective that provides further detail or definition to meet the for a program required-capability. Each objective has a set of related attributes, which define it in further detail. In FIG. 3, “required-capabilities” refers to those organizational abilities necessary to accomplish a specific capability group (i.e., baseline, core, contingent and reactionary) for a specific program. Furthermore, FIG. 3 illustrates, within a system of systems architecture, the hierarchical cascading of the fulfillment of attributes rolling up into objectives for particular capabilities to provide the readiness factor.

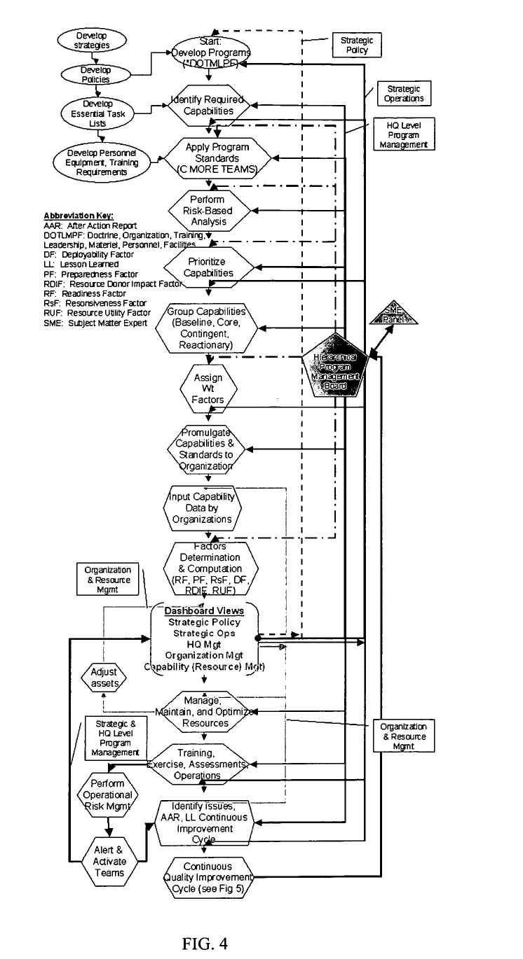

The application of the general concepts described above are summarized and illustrated in FIG. 4. Details depicted in FIG. 4 are further delineated below, however, as shown in FIG. 4, specific standards are applied to pre-defined and determine required-capabilities. Specific required-capabilities are then determined based on necessary requirements for capability groups and weight factors are assigned, which are further discussed below. Ultimately, the process yields an accurate and real-time analysis of an organization, based on organization-wide standards, and advice on how the organization can be adjusted or modified in order to maximize mission completion capability of the organization.

The results produced from application of the method can be directly applied simultaneously by managers at various layers of the incident management system recognizing that an overall hierarchy must merge disparate command systems' data supporting the incident into a common operating picture. The results produced from the method provide advice to managers at multiple levels on what specifically must be changed or altered within an organization to meet mission or task requirements for the organization. Such a model provides general visibility on layers of management for development of chain of command, hierarchical structure, read/ write rights for data input, responsibility for veracity of that data, and action requirements within the program standards. Each required-capability is defined across these layers, as appropriate, with as specific as possible a definition of the key positions or billets with respect to management requirements, reporting structure, and read/write rights for data accessibility within the computer program.

Particular use of the method will differ depending on the layer of management of the user. Doctrine and policy are incorporated into the method by having available ready reference to pertinent policy, statutes, guidelines, instructions, and manuals that define and drive those program standards, or plans that utilize the capabilities. If the method is incorporated into a computer program, then the tool can be built with hyperlinks to important references. The doctrine and policy are included under the “capability” program objectives and their “attributes” (e.g. references, scope, mission, concept of operations (conops), and local plans) that better define the program standards. Except for local plans and local factors affecting concepts of operations, these will be centrally managed through administrative headquarters.

The inventive method contemplates providing a means for updating requirements to meet regulatory statutes or policy updates by alerting managers to specific areas brought out of compliance by any changes to the attributes of the program objectives. Additionally, as an example, as hazard vulnerability assessment, threat assessments, or actual response requirements dictate, required-capabilities can be developed and analyzed using the risk-based approach methodology to prioritize spending for more effective required-capabilities.

A preferred embodiment, as previously illustrated in FIG. 1, includes the program objectives: capability; manning; organization; recognition; equipment; training; exercise; assessments; maintenance; sustainment. These capabilities are captured as the acronym “C MORE TEAMS.” However, the invention also contemplates the addition of other or different program objectives, depending on the organization where the method is applied.

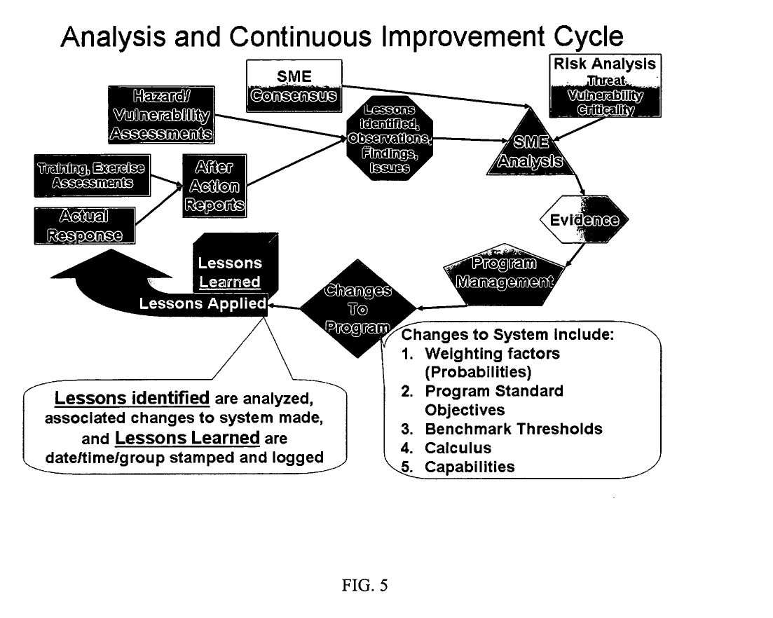

The attributes of the program objectives provide further definition of the infrastructure being evaluated. These attributes can be modified as dictated by a continuous improvement program using an evidence-based decision process, such as depicted in FIG. 5. FIG. 5 demonstrates a classical statistical approach. Alternatively, using Bayesian inference and hierarchical Bayesian analysis or chaos theory fractal phasing, an alternative approach may be used to allow for accounting of known background information that may actually impact readiness. Although objectives and attributes can be defined for specific organizations, a preferred embodiment, or medical facilities is illustrated in the acronym CMORETEAMS and is defined as follows:

### Program Objectives and Respective Attributes

1. Capability

a. Mission, scope, purpose, assumptions (and/ or specified and implied tasks).

b. Concept of Operations

c. Policy references Capability Roles and Responsibilities in Local Emergency Operations Plan Hazard Specific Annex

d. Capability Mission Essential Task List

2. Manning

a. Position descriptions, team/ squad leader, assistant, supply manager, training manager, maintenance manager, equipment manager (LASTME), other unique positions,

b. Succession order defined

c. Personnel accountability data, “readiness” data

d. Conflicts in assignment

3. Organization

a. Incident Management System (Operational, Tactical Chains of Command)

b. Administrative chains of command,

c. Communications protocol and plan

d. Succession plan

4. Recognition

a. Integration, interoperability issues,

b. Tactics, Techniques, Procedures (TTP)

c. Critical action item lists, essential task lists, Job Action Sheets

d. Mutual Aid Agreements/ MOU's, MoA's

5. Equipment and Supplies

a. Family of Systems list

b. Actual equipment on hand, proper storage location, and status

c. Communications gear

d. “Go Bags” on hand, properly stored, inspected, maintained

6. Training

a. Individual Training Status
Baseline CBRNE training
Equipment training
Personal Protective Equipment (PPE) Training
Role/position Squad Training
Functional or Full Scale Exercise
Competencies (as appropriate)
Specific OSHA, National Fire Protection Association (NFPA) required
“qualification” training
Credentialing and Privileging, certifications, qualifications
Relative Value Units (RVU's)

b. Squad training status

7. Exercises

a. Frequency

b. Duration

c. Participation

d. Goals, master event scenario list (MESL)

e. Training obtained during exercises captured
i. Relative value units
   8. Assessments

a. Exercise Assessments
i. Capability Measures of Effectiveness
   Measure of Performance of essential tasks
   Measure of Suitability
ii. After Action Report (AAR) system
iii. Lessons Learned System (Joint, service, and institution specific)
   Higher order effects analysis
   Critical failure point, single points of failure

b. Annual Hazard Vulnerability Assessment (HVA)

c. Joint Commission for Accreditation of Healthcare Organization (JCAHO), Joint Staff Installation Vulnerability Assessment (JSIVA), Chief, Naval Operations Installation Vulnerability Assessment CNOIVA (e.g., service specific IVA Programs)

d. Threat Assessments

e. Continuous Improvement Cycle Program

9. Maintenance

a. Equipment maintenance and availability (time between maintenance work)
i. Depot level
ii. User level

b. Shelf life extension Program

c. Supplies

d. Training

e. Exercises

10. Sustainment

a. Management
Personnel

b. Life-cycle equipment management

c. Program Objective Memorandum (POM) funding

d. Equipment, supplies, training, exercise, and assessment costs

e. Relative Value Units (RVU)

f. Notional capability cost estimates

The objective “capability” in the preferred embodiment C MORE TEAMS captures an organizations policy, scope, purpose, mission and basic concept of operations for a given required-capability. The “manning” objective provides for development of the roster of personnel, including alternates, with pertinent associated information allowing for logistical support, personnel accountability, individual medical readiness, and data for development of such things as time phased force deployment data (TPFDD), in the case of military or other globally oriented organizations. Position descriptions designate key positions, to include the team or squad leader, assistant, equipment manager, maintenance manager, and any unique positions required for a given capability. Line of succession is also designated by a roster numbering scheme. Personnel may be on more than one capability resource, but should meet training requirements for all on which they are listed, and must be substituted if conflicts are identified between capability employments. Algorithms will determine which capabilities represent potential conflicts and should not designate the same personnel. For example, a person should not be assigned to a decontamination (decon) team and triage team for chemical incident mass casualty response. Such conflicts will be flagged in order to alert program managers.

Appropriate personnel data will be pulled from the appropriate administrative databases able to provide the required data fields, or recorded manually. Manning rosters will be linked to training files with the appropriate training records for an assigned capability visible. Accountability data can provide biographical identification capability to ensure compliance with specific program standards such as antiterrorism (AT) and Force Protection (FP) program standards. Visibility of personnel availability, training qualifications and conflicting assignments with respect to readiness measures will allow selection of properly trained and equipped team members.

The “organization” objective represents the operational command and control within the vertical integration and reporting requirements including the incident management system. It also includes the administrative chain of command and hierarchical management, communications protocols, and succession plan.

The “recognition” objective comprises horizontal integration and interoperability issues, for example, how given capabilities interface with other capabilities, capturing those issues in terms of such things as sharing of equipment, command and control, communications, oversight, and operational authority. For example, in healthcare organizations, who has medical oversight of patients through the decontamination process when there may be no medical providers on the decontamination team and how that oversight is transferred through the decontamination corridor is determined within the required-capability standards to be reflected in plans, training and exercises. Universal joint task lists (UJTL) or mission essential task lists (METL) specific to a particular required-capability are referenced here. Tactics, techniques, and procedures (TTP) are managed here. Check lists of critical action items for personnel associated with the capability (similar to the job action sheets of the hospital incident command system (HICS)) are maintained here and updated based on assessments and as needed. In healthcare facilities, for example, the integration of the decontamination capability with the triage and treatment capability establishes such things as medical oversight of patients through both processes, intervention procedures, patient hand-off techniques and responsibilities, and command and control. Any interorganization agreements are referenced at this level, such as Mutual aid agreements (MAA), Memorandum of Understandings (MOU), and Memorandum of Agreements (MOA).

The “equipment and supply” objective lists specific equipment and supply lists for given capabilities either as the specific list or as a family of systems from which to choose. Communications gear and plans are noted here. Minimum standards are promulgated for inspection purposes. Actual equipment and supplies on hand with proper storage location, condition, and status are captured here. Comparison is made against the specified equipment list or family of systems, with deviations and exceptions noted in the tickler, warning, and reporting system.

The “Training” objective is determined by minimum standard requirements as designated by a given program's maximum requirement and recorded as qualification. This qualification has sustainment training requirements that must be met. It also qualifies this person system wide as long as it is maintained. For example, Occupational Safety and Health (OSHA) and National Fire Protection Association (NFPA) provide minimum training standards for first responders, first receivers (guidelines), and hazardous materials workers and likely provide the minimum standard for “qualification” purposes for personnel serving in those roles.

Minimum standards are determined for a given capability, as is sustainment, advanced, and expert (train the trainer) level training. Training data provided from appropriate databases will compare completed training to training requirements for the role being filled and note deficiencies. Credentialing and privileging information may be included in accordance with appropriate requirements. Training is also cumulative and cross applicable, such that training for one capability may be applicable towards the training requirements of other capabilities. This allows managers to identify specific training (such as specific equipment training) that can be done easily to expand the potential manpower assets available for various capabilities. On-the-job training during actual incidents will be at the discretion of managers with the appropriate expertise and experience after making the proper risk assessment.

The “exercises” objective ensures training exercises are recorded both in terms of type, duration and frequency. Time spent during exercises counts towards practical application training requirements for qualification. Frequency is determined by program standards, again established to meet the most stringent requirements to which the organization adheres. For example, medical organizations adhering to Joint Commission on Accreditation of Healthcare Organizations (JCAHO) would meet or exceed those exercise requirements, which require more frequent exercises than Department of Defense Installation Preparedness Programs. Various programs of record within industry might also drive the schedule.

The “Assessments” of training and exercises are captured as a formal program standard and are submitted in the form of After Action Reports (AAR) or Lessons Learned (LL), and are used to develop, evaluate, or validate tactics, techniques, and procedures (TTP) for the capabilities. These are entered into a formal continuous quality improvement program ensuring they are reviewed at the appropriate level within the organizational hierarchy, analyzed, and used to modify existing standards. The reader is again referred to FIG. 5 for an illustration of this process. Comparative standards matched to mission essential task lists or job action sheet requirements will provide exercise controllers objective standards with which to measure performance in exercises. These will provide a way to compare performance against standards, other units, or same units sequentially to monitor changes in performance.

The “Maintenance” objective captures equipment and supply storage management. Each capability with equipment has an assigned maintenance manager and equipment manager charged with ensuring proper maintenance is conducted, and proper storage maintained. Maintenance schedules are tied to the tickler, warning, and reporting system.

The “sustainment” objective ensures sustainment of the program through proper budgeting for adherence to program standards. This includes operations and maintenance funding; equipment life-cycle replacement costs; supplies, training, exercise, and assessment costs including relative value unit (RVU) costs; and personnel. Sustainment figures are used in risk-based cost benefit analysis for capabilities as well as for estimates of logistical support during operations. Figures should include actual costs to sustain a given capability, and may include notional cost estimates to sustain a capability through various program standards to allow for visibility on cost to achieve a given level of readiness.

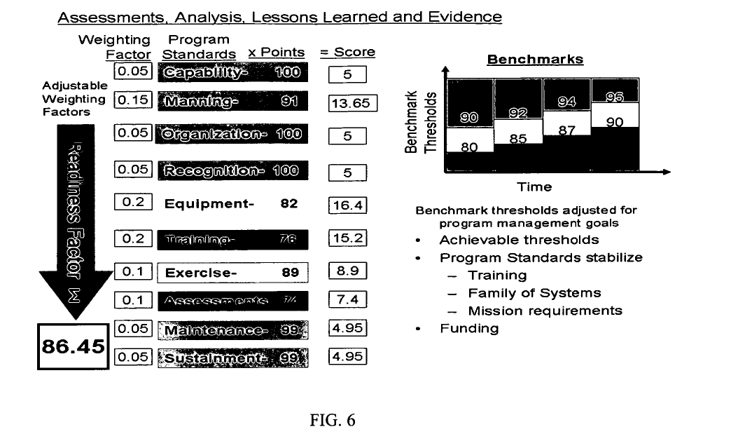

Additionally, rank-ordering the program standards provides a framework for measuring “readiness” for a given capability, providing a “readiness factor” (RF). This is illustrated in FIG. 6. The weighting factors illustrated in FIG. 6 are initially determined by subject matter experts. The “points” are obtained, in this example, from a statistical combination of the attributes for that objective normalized to 100. However, other scoring methods are contemplated.

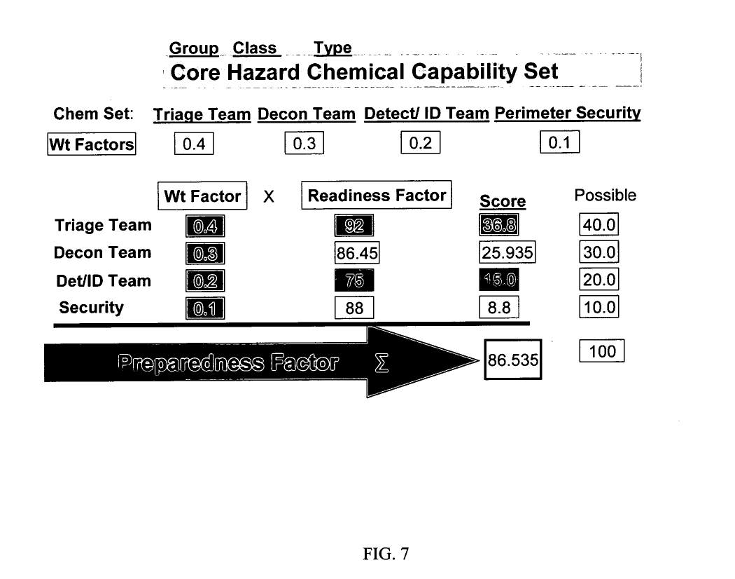

As mentioned above, “required-capabilities” are defined to represent the combination of requirements to adequately equip, train and organize personnel and assets in order to integrate to perform a planned function defined, for example, through the C MORE TEAMS objectives. The physical manifestation of this is the “resource.” As a resource meets more of the program standards, it achieves a greater readiness factor. As previously mentioned, required-capabilities are further grouped into “capability groups or sets depending on their application towards specific types (e.g. hazard or functional, as illustrated in FIG. 2) and the threat or risk of those specific types occurring. Core required-capabilities are mapped to specific, scenario-based types (e.g., hazard and functional) based on the risk analysis of potential hazards, vulnerabilities, required missions or tasks or other directed requirements. These sets then define the level of adherence required against the program standards, allowing optimal management under given fiscal constraints. As specific resources meet more of their required-capability standards, they achieve higher readiness factors, and their combined readiness factors provide higher preparedness for a given institution such that the preparedness factor (PF) can be defined as the probabilistic representation of an organizations readiness for responding to a given mission requirement such as a specific hazard incident. This is illustrated in FIG. 7.

Through checks, employment of threshold trigger values and user rights to provide input, and visibility, management at various layers within a hierarchical chain of command can provide oversight to accomplish critical tasks appropriate to that layer of management. Using warning flags and reports, especially if the method is incorporated into a computer language, deficiencies in meeting program standards allow real-time assessment of readiness and preparedness factors, better operational risk management decisions to be made, and a mechanism for measuring the effectiveness of program standards and required-capability definitions. Additionally, a risk-based analysis, integral to the method can help determine in which set a given capability will be placed.

The method, incorporating an analysis of specifically determined capabilities and standards that have been hierarchically order based on importance, is utilized to determine a “Readiness Factor” for a given capability. Readiness Factor is determined by taking the sum of the program standards achieved through the C MORE TEAMS construct. As mentioned earlier, each program standard is assigned a weighting factor to designate the relative importance of that standard in achieving readiness. In a probabilistic model, these weighting factors represents the probability that failure of a given program standard will ultimately lead to a mission failure or significant detriment in outcome. Readiness Factor is determined according to the general formula:
Capability “Readiness Factor” (RF)=ΣPS×WtF

PS=Program standards achieved score

WtF=Weight Factor associated with significance of program standard

Again referring to FIG. 1 and FIG. 7, “preparedness factor” is determined by considering only the capabilities within a particular “type” set (such as chemical incident response) and taking the total sum of the product of the readiness factors and an assigned weighting factor designating the relative importance of that capability within the specific capability type set according to the formula:
Institution Preparedness (core set)=Σ Capability (specific core set) RF×WtF

RF=Readiness Factor

WtF=Weight factor associated with priority of the capability within the set

In a probabilistic model, the assigned weighting factors represent the probability that failure of that capability leads to significant failure or decrement to the mission. FIG. 3 illustrates the hierarchical relationship of the capability readiness factors, RF, with an organization's preparedness factor, PF. At the local level, this method results in a determination that is ultimately utilized by managers to not only monitor their resources for compliance to the program standards. The result from the use of the method may also be directly utilized by managers to further determine deficiencies in various resources and ascertain how to develop the various resources from a pool of assets available (e.g., trained personnel and approved equipment) to meet a given response requirement. Because the capabilities and standards are ordered based on importance, the manager, using the results from method, can more readily assigned available limited and critical assets to the development of a capability resource in order to increase preparedness.

Thus, if critical assets are pulled from an organization to support a separate mission requirement, the order of replacing those assets to optimize readiness and preparedness is made plainly visible. Such an example might be replacing personnel pulled from a military hospital to support a combat surgical hospital military platform. The invention method allows program managers to utilize the limited, remaining assets to optimize their readiness and preparedness for the emergency management program by making assignments to achieve the highest factor scores.

As a further illustration, as mentioned above, “baseline capabilities” represent the day-to-day operations of the institution that require real-time visibility at the local or hierarchical levels and represent the asset pool of resources from which other capabilities are built. “Core capabilities” represent those capabilities that must be in a “ready” posture meeting the program standards defined by C MORE TEAMS, and remain visible to the hierarchical chain for overall readiness management, preparedness, planning, and response. Therefore, for example, “Core CBRNE” (chemical, biological, radiological, nuclear, explosives) include such capabilities as “Triage and Treatment”, “Medical Transport”, “Decontamination”, “Detection/ID” are included and differentiated from non-CBRN due to the need for following guidelines related to working in uniquely hazardous environments. These drive the need for specialized training and equipment such as personal protective equipment (e.g., chemical suits, gas masks, gloves, and boots), detection equipment, and decontamination equipment (e.g., roller systems, tents, shower systems).

Likewise, “contingency capabilities” represent those capabilities that do not require a readiness posture, but might be called upon to respond to specific response requirements. These include capabilities that might be called upon to provide baseline capabilities elsewhere, and that could be built relatively rapidly, meeting manning, training, and equipment standards, but not requiring periodic exercises or assessments. Cost estimates may be developed in order to perform risk-based analysis.

As mentioned above, “reactionary” capabilities represent response teams built “on the fly” to respond to extraordinary events with available assets in the baseline and core sets. These capabilities do not require prior planning, but allow for standards to be developed and managed centrally or locally with the benefits of the method for management and visibility. Analysis of the developmental needs of this capability group would be conducted as for “core” capabilities.

For each of the capabilities, “tiering” allows for differences in the sizes of institutions in terms of baseline capability sets or in terms of the mission requirements and is managed by applying the same program standards, but requiring fewer capabilities for smaller institutions with fewer resources. An example of the application of tiering is to define capabilities in the smallest modular components that allow for simple “dropping out” of capabilities from the baseline and core sets.

The contemplated method permits managers to conduct a “Risk-based Analysis”, which allows a comparison of capabilities against each other based on their ability to decrease a given risk per cost. Results of this risk-based analysis are then utilized by the manager to make decisions that permit better allocation of limited resources towards capabilities that are more effective. As capabilities are prioritized across the horizontal axis, those that are more critical are placed ahead of less critical and into “groups or sets” that either do or do not require adherence to the program standards (e.g. core and contingency, respectively). Incorporating the time for a given capability to be in response mode provides a “responsiveness factor” (RsF). The inclusion of sustainment information allows risk-based decision making.

Risk can be defined a number of ways, depending on what institution that the method is being applied. However, a preferred embodiment is to define risk as a function of threat, vulnerability, and criticality. Information on vulnerability, threat and criticality assessment contains a significant element of subjective determination through formal program assessments. Criticality features include replacement cost and replacement time, vulnerability, strategic significance, and impact of loss while awaiting replacement.

Therefore, the method permits the manager to make a determination whether a specific capability should be funded based on the formula:
Capability effectiveness=Risk (T,V,C)_{Baseline}−Risk (T,V,C)_{Capability applied}

Risk(T, V, C)=Risk as a function of Threat, Vulnerability, Criticality

RF=Readiness factor

PF=Preparedness factor

RsF=Responsiveness factor

The Capability Cost Effectiveness is then the Capability Effectiveness for a given capability divided by the cost to maintain (annual budgeting) and sustain (life-cycle costs) that capability, according to the formula:
Capability cost effectiveness={[Risk(T, V, C)_{Baseline}]−[Risk(T, V, C)_{Capability applied}]}/cost of the capability.

Including sustainment information allows risk-based decision making. As capabilities are prioritized across the horizontal axis, those that are more critical ar4e placed ahead of less critical capabilities. Capturing cost for a given capability (or group of capabilities) in sustainment allows comparison of the placement of the capability into the core set vs. contingency set where readiness and preparedness are decreased, but so is cost.

Other metrics determined by the method include “responsiveness”, “deployability” and resource utility factor (RUF). Responsiveness captures the ability of a capability to be mission ready including integration, and setup time. Within a regional construct, this provides greater visibility before, or in response to, a given incident, the assets available to respond, and the risk for a given level of preparedness and readiness. Responsiveness is determined according to the formula:
Responsiveness Factor (RsF)=1/[Tₘᵤₛₜₑᵣ+T_{load}+T_{APOE}+Tₐₜ+Tₜᵣₐᵥₑₗ+T_{debark}+T_{obj}+Tₛₑₜᵤₚ]

Tₘᵤₛₜₑᵣ=Time to recall members, ready equipment

T_{load}=Time to load equipment onto road vehicle for local movement

T_{APOE}=Time to travel to a port of embarkation (e.g. airport or seaport)

Tₐₜ=Time awaiting transportation

Tₜᵣₐᵥₑₗ=Travel time including conditions (i.e., weather, traffic flow, detours, etc)

T_{debark}=Time to debark at port of debarkation

T_{obj}=Time traveling to objective site

Tₛₑₜᵤₚ=Time to setup and be ready to perform capability on site

Deployability describes the ability of a resource to be deployed safely and effectively and is dependent on the “weight and cube” of personnel and equipment, ruggedness of equipment, logistical support requirements (e.g., fuel and power requirements), and transportability of equipment (e.g. including hazardous materials). Deployability is determined according to the formula:

$$Deployability factor = \frac{Ruggedness}{( Weight , Cube , Log Support requirements , Hazmat Material )}$$

Resource Donor Impact (RDI), the numerical manifestation of which is termed Resource Donor Impact Factor (RDIF), is a function of the criticality (e.g., time, ability, and cost to replace) of the component assets of a given capability, be they equipment or personnel, for baseline and/or core capability sets. RDI allows for accounting for key essential personnel and assets in order to minimize the impact on the institution donating the resource. This factor is inversely proportional to the capability utility and is a factor of resource utility.

Resource Utility Factor (RUF) is a measure of the qualities that make the selection of a particular capability favorable on a comparable basis. Being that it is dependent particularly on actual capability available vice what is required through capability program standards, it is represented by the combination of factors as determined by the most recent data available. It is determined as follows:
Resource Utility Factor=Wt1(RF)×Wt2(RsF)×Wt3(DF)/Wt4(RDIF)
RF=Readiness factor
RsF=Responsiveness factor (geospatial time, distance, transport capability)
DF=Deployability factor
RDIF=Resource Donor Impact Factor
Wt=Weighting factors

The method can be utilized to provide advice to managers, at multiple levels, in conducting Operational Risk Management (ORM), as illustrated in FIG. 4. The method permits management decisions by standardizing resources and applying a readiness metric algorithm at lower levels of management enabling valid comparison for operational employment, preventive redistribution of resources, or recognition of potential vulnerability. Direct comparison for planning or response allows selection of those resources that have better “readiness”, “deployability”, and “responsiveness factors” or “resource utility”, while causing less impact on the donor institution. By integrating all operational mission requirements with appropriate oversight at the appropriate level of the chain of management, resources are managed more efficiently. Visibility of the resources available within a desired region, their current readiness status, and their association to other duties, provides insight for resource-based planning decisions by managers at all levels of the management hierarchy.

As previously mentioned, the tool can be utilized by managers up and down the management hierarchy. Through the tool, “measures of effectiveness” (MoE) can be developed and optimized through programmatic review of compliance to standards. Using the institution status, analysis of causes for noncompliance can be cross-walked with the family of like institutions in a given tier to identify common issues with compliance of program standards, and those standards can then be adjusted accordingly. Commonly occurring exceptions to program standards granted to particular institutions can also be analyzed. Additionally, through assessments, after action reports, and lessons learned, root cause analysis can be used to attempt to identify a specific element within the system causing or contributing to a decrement in mission or mission failure, such as an attribute poorly defined or wrongly excluded or included, or a capability not identified. Adjustments can then be made system wide to address items of concern with weighting factors adjusted accordingly. Fiscal constraints to overall program management can also be addressed through the risk-based analysis above. Finally, data from real-world responses can be vetted against the current program to compare cost versus benefit, and proper adjustments made.

The method also provides advisory framework by which an institution can be inspected for compliance with established programs. Verification by inspection of a small percentage of the capabilities against the standards can give a statistical picture of compliance. Indications of non-compliance would warrant further inspection and might result in appropriate disciplinary action or administrative assistance for program management. The method can be vetted against Hazard and Vulnerability Assessments and threat assessments to determine adherence or compliance with that assessment. Standard questions for such assessments can be identified and mapped to specific capability standards to drive compliance and, through computer-based tools, allow for rapid summation reports of adherence to those questions from a particular assessment.

Providing appropriate visibility of current status of these factors at various hierarchical levels of management enables managers the ability to optimize readiness and preparedness with the assets available. In planning for a mission this permits managers to utilize those resources and manage risk by choosing those that are more ready, more favorably located, or whose use has less impact on the donating institution.

Compliance with program standards provides visibility of the current status of resources to a hierarchical oversight administrative chain of command. Flagging deficiencies in meeting the program standards through a systematic warning and reporting algorithm assists managers in meeting program requirement. This is especially true if the method is incorporated into a computer program. Types of alerting notifications contemplated within the method include:

“Ticklers” alert the responsible manager of a pending program standard requirement that if not addressed and, will result in non-compliance and a decrease in readiness and preparedness factors. These will be standardized and centrally managed.

“Warnings” alert the responsible manager and the next level manager that a tickler has not been addressed and is past due.

“Reports” alert the central headquarters that a warning has not been addressed at the local level within a specified grace period, and further assistance may be required.

“Status” refers to a summary flag status for all capabilities of a given institution.

“Exceptions” describe an allowed deviation from program standards by exemption or variance. These are made at the central headquarters level.

“Conflicts” define roles that are incompatible or conflict and cannot be assigned to the same person or equipment to develop or provide a capability.

In a preferred embodiment, the method will incorporate a flagging system. The flagging system will be tailored to each layer of the hierarchical scheme with more specificity at lower layers of management. Flagging will provide a color-coded icon alerting the status of capabilities for a given institution. A four-place alpha-numeric code will define the specific deficiency as follows:

1st letter designates program standard (e.g., C, M, E, e, A)

2nd letter designates attribute of that program standard

3^{rd} and 4^{th} numbers designate manning roster number affected.

Color codes will be as follows:

Green: fully compliant

Yellow: compliance at risk within a certain timeframe

Red: capability not in compliance with program standards

Purple: capability currently deployed, not available for further use

Gray: conflict risk exists

In final form, the inventive method is designed for capabilities management based on specific programs standards within an organizational hierarchy. It attempts to model capability as a system of systems, identifying and organizing the essential components and assigning a value of importance to each as it contributes towards that capability's ability to perform its mission. It then overlays in matrix format the organizational management hierarchy and allow for proper data management of the capability within that organizational hierarchy. The organization can have multiple layers of management (such as districts or regions), and can use the method for any capabilities-based program. The reader is again referred to the flow diagram of the use of the method in FIG. 7. Depending on the management layer at which the method is used, it provides program management capability and readiness, institutional preparedness and status, and response capabilities to meet given mission requirements. Additionally, if program standards are based on organizational policy and statutes, it can be used for inspection purposes.

The method incorporates a dashboard display that is customized for specific layers of management. In a preferred embodiment, The Enterprise Dashboard will display all centers or facilities in a given organization with core set preparedness values and the ability to drill down to individual capability readiness values both based on the preparedness and readiness factors. Colors will provide additional “at a glance” information. Rights for data entry and access will vary by layer and position.

Having described the invention, one of skill in the art will appreciate in the appended claims that many modifications and variations of the present invention are possible in light of the above teachings. It is therefore, to be understood that, within the scope of the appended claims, the invention may be practiced otherwise than as specifically described.

What we claim is:

1. A method for analyzing and optimizing organizational resources comprising the steps:
a. determining required-capabilities and required programs for an organization;
b. determining readiness and preparedness and responsiveness factors of said required-capabilities;
c. adjusting material and equipment resources and personnel training based on advice obtained from said level of readiness and preparedness of said required capabilities.

2. The method of claim 1, wherein the required-capabilities are further defined by one or more objectives and where said objectives are further defined by attributes.

3. The method of claim 1, wherein said readiness factor is determined for each of said required-capability by determining which of said objectives are met and multiplying each of said program standards met by said program standard's weight factor according to the formula: Readiness Factor=Σ program standard×weight factor.

4. The method of claim 1, wherein said preparedness factor is determined by taking the sum of the product of the readiness factors multiplied by a weighting factor of each of the required-capabilities according to the formula: Preparedness factor=Σ capability readiness factor×weight factor.

5. The method of claim 1, wherein said responsiveness factor is determined according to the formula: responsiveness factor=the inverse of time to recall members and to ready equipment plus the time to load equipment onto vehicles plus the time to travel to a port of embarkation plus the time awaiting transportation plus the travel time plus time to debark plus the time traveling to objective site plus the time to setup and be ready to perform the capability.

6. The method of claim 1, comprising the additional steps of determining the operational risk to select most appropriate resources based on time, distance to mobilize capability gap and cost by determining deployability factor, capability effectiveness, capability cost effectiveness, resource deployability impact factor and resource utility factor.

7. The method of claim 1, wherein said determinations are displayed onto a dashboard display wherein said dashboard contains an advisory color-coded flagging system indicating that a capability is either fully compliant, compliance is at risk within a certain timeframe, capability is not in compliance with program standards, capability is currently deployed and not available for further use or a conflict risk exists.

8. The method of claim 1, wherein said required-capabilities are standardized throughout said organization.

9. The method of claim 1, wherein said method is incorporated into a computer program and wherein said method is carried out by said computer program.

10. The method of claim 1, wherein said responsiveness factor is a measure of the ability of said organization to commence actions of its mission by the inverse of the sum of time to respond and commence said action.

11. The method of claim 1, wherein said advice is available to all layers of management within said organization.

12. The method of claim 1, wherein said attributes of said objectives and said weight factors of said attributes, objectives and required-capabilities are modified by the steps:
a. determining the success or failure of exercises, training and missions and analyzing the cause of the failure or success of said exercises, training and missions;
b. reviewing said analysis of said success or failure of said exercises, training and missions;
c. modifying said attributes, objectives and required-capabilities based on said analysis of success or failure of said exercises, training and missions.

13. The method of claim 1 also including the steps of providing additional advice by providing ticklers to alert of a pending program standard requirement that if not addressed will result in a decrease in readiness; providing warnings that will alert the operational manager and the next level manager that a tickler has not been addressed and is past due; developing reports that alert of a said warning that has not been addressed and that further assistance is required; defining exceptions from program standards; and defining conflicts that may become incompatible or conflict and cannot be assigned to the same person or equipment.

14. The method of claim 2, wherein the required-capabilities are further defined by one or more groups as either baseline, core, contingent or reactionary where said baseline represent day to day capabilities, where said core represent those capabilities that are needed to meet said organization's standards, where said contingent represent those capabilities that are not required by said organization's standards but might be called upon for specific requirements, and where said reactionary represents capabilities that are built in response to extraordinary but not predictable events with assets available in the baseline and core and where said baseline, core, contingent and reactionary groups are predetermined requirements.

15. The method of claim 6, wherein said deployability factor is determined by ruggedness divided by characteristics including weight, logistical support requirements, and inclusion of hazardous material.

16. The method of claim 6, wherein said capability effectiveness is determined by subtracting the risk of a particular capability from the baseline risk.

17. The method of claim 6, wherein said capability cost effectiveness is determined by dividing the cost of a particular capability into the product of said capability effectiveness times said responsiveness factor, preparedness factor and readiness factor for that capability.

18. The method of claim 6, wherein said resource utility factor is calculated by dividing the resource donor impact on an institution in donating a capability resource towards a response based on the criticality of the component assets of a given capability, multiplied by its weight factor, into the product of said readiness factor, responsiveness factor and deployability factor multiplied by the weight factors for said readiness factor, responsiveness factor and deployability factor.

19. The method of claim 7, wherein the allocating of resources for specific missions or tasks is based on results annotated on said dashboard display.

20. The method of claim 7, comprising the additional step of reviewing said dashboard display and adjusting personnel, training, equipment or other assets of said organization based on the advisory annotations on said dashboard display.

21. The method of claim 11, wherein designated layers of said management have the ability to provide data input into the method and where said designated layers are determined by the highest layer of said organization and where said data input includes correction, additions and subtractions to available resources within said organization and changes to said program standards and said capabilities.

22. The method of claim 14, wherein the objectives are assigned a numerical weight factor associated with the significance of each of said objective for a given required-capability and, wherein the required-capabilities are assigned a numerical weight factor associated with the significance to each of said required-capability.

23. The method of claim 15, wherein compliance of each of said required-capabilities with each of said standards is determined.

24. The method of claim 16, wherein said compliance is used to assign a numerical number of said required-capabilities with said objectives.
